(19) United States
(12) Patent Application Publication
(10) Pub. No.: US 2019/0343141 A1
(43) Pub. Date: Nov. 14, 2019

(54) OIL AND FAT SUBSTITUTES

(71) Applicant: ACH Food Companies, Inc., Oakbrook Terrace, IL (US)

(72) Inventors: Michael T. Bunczek, Lisle, IL (US); Fulya Eren, Beecher, IL (US); Martha E. Cassens, Chicago, IL (US); Phyllis D. Thompson, River Forest, IL (US); Kelly J. Johnson, Chicago, IL (US); Helene M. Chaisson, Downers Grove, IL (US)

(21) Appl. No.: 15/976,631

(22) Filed: May 10, 2018

(51) Int. Cl. A23D 7/015; A23L 33/21; A23D 7/005

(52) U.S. Cl. CPC A23D 7/015; A23V 2002/00; A23D 7/0053; A23L 33/21

(57) ABSTRACT

A plant-based soluble dietary fiber formulation can be used as an oil and fat substitute. It can be a fluid or solid (frozen or dry). The oil and fat substitute can be an aqueous mixture, comprising soluble dietary fiber. This mixture can be used in cooking, sautéing, baking, and food preparation in place of oils and fats. The oil and fat substitute can be in dry form and used in dry mixes for baking, sauces, gravies, dressings, and the like in place of oils and fats.

### BACKGROUND

Consumers continue to seek healthier diets by reducing fat or calories in their food. However, previous oil and fat substitutes have resulted in potential digestive issues, negative sensory issues, negative label perception, difficulties in usage, and limited range of applications.

The oil and fat substitutes (FIB-OIL) of the present application provide numerous benefits, including a reduction in calories; a reduction in fat; the addition of soluble fiber; a less greasy feel or texture, mouthfeel, and oily taste; a slight sweet flavor that can reduce negative notes and/or enhance flavor profile; and the ability to enhance flavor and texture of more bland foods while maintaining or improving nutritional benefits. FIB-OIL can be used as an ingredient in food, or as the cooking medium, such as for sautéing.

### SUMMARY

FIB-OIL comprises soluble dietary fiber. FIB-OIL can be a fluid or solid (frozen or dry). It can be used in cooking, sautéing, baking, and food preparation in place of oils and fats.

### DETAILED DESCRIPTION

FIB-OIL, a plant-based soluble dietary fiber formulation, can be used as an oil and fat substitute. FIB-OIL can be an aqueous mixture comprising plant-based soluble dietary fiber. This mixture can be used as an oil and fat substitute in cooking, sautéing, baking, or food preparation. The aqueous mixture can be provided in either liquid or solid form. The aqueous mixture can be, for example, frozen, refrigerated (to increase viscosity), heated (to reduce viscosity), or blended with other ingredients to form gels, pastes, etc.

FIB-OIL can also be used in its dry form, such as powder or flakes, where the plant-based soluble dietary fiber formulation can be substituted for dry forms of oils or fats. The dry form can be substituted for oils or fats in dry mixes such as powdered cake mixes or other dry convenience foods, including but not limited to dry mixes for sauces, dressings, gravies, and the like.

The FIB-OILs of the present application comprise plant based soluble dietary fiber. The plant-based soluble dietary fiber can include one or more of corn fiber; wheat fiber; cereal grains including rice, barley, tapioca, and the like; pulses and legumes including yellow pea, chick pea, and pinto bean; and other known plant-based soluble dietary fibers, including polydextrose, partially-hydrolyzed guar gum, pyrodextrin, dextrin, and modified versions of these. Such products are commercially available and include the following: Nutriose FM06 (soluble corn fiber); Promitor 85 (soluble corn fiber); SunFiber (partially-hydrolyzed guar gum); Litesse (polydextrose); Litesse II (polydextrose); Litesse Ultra (polydextrose); and Nutriose FB06 (soluble wheat fiber).

The Nutriose line of dietary fiber ingredients is marketed by Roquette (Roquette Freres). Nutriose soluble fibers are food dextrins made from wheat or maize starch and are described in U.S. Pat. No. 5,620,871, the disclosure of which is incorporated by reference herein.

Fibersol 2 is produced and marketed by a joint venture between ADM (Archer Daniels Midland Company) and Matsutani (Matsutani LLC). It is classified as resistant maltodextrin in the USA and is produced by dextrinization of starch followed by a proprietary enzymatic molecular weight reduction of the dextrins. It is described in U.S. Pat. No. 5,358,729, the disclosure of which is incorporated by reference herein.

Tate & Lyle's Promitor Soluble Corn Fiber ingredients are produced by heat treatment of starch hydrolysis products at low pH. They can be classified as corn syrup or maltodextrin, depending on the molecular weight of the resulting product. Such products are described in U.S. Pat. No. 7,608,436, the disclosure of which is incorporated herein by reference.

The fiber composition and concentration can affect the color, flavor, mouthfeel, and viscosity of the FIB-OIL, or the food product into which it is incorporated.

The plant-based soluble dietary fiber can be dissolved or mixed in water to form an aqueous mixture. In some embodiments, the aqueous mixture comprises 5-80% by weight plant-based soluble dietary fiber. In other embodiments, the aqueous mixture comprises 25-50% by weight plant-based soluble dietary fiber. In other embodiments, the aqueous mixture comprises 5-50% by weight plant-based soluble dietary fiber.

In some embodiments, the FIB-OIL can further comprise at least one of oils and emulsifiers, in addition to the plant-based soluble dietary fiber. Oils and emulsifiers known in the industry can be incorporated into the FIB-OIL of the present application. Oils can include one or more of the following: corn oil, olive oil, canola oil, soybean oil, coconut oil, and other known plant-based oils. Emulsifiers can include one or more of the following: lecithins, mono- or di-glycerides, citric acid ester of monoglycerides, sucrose (fatty) esters, polyglyceryl esters, propylene glycol esters, polysorbates, cyclodextrins, and other emulsifiers known in the food industry.

The oil and/or oil composition and concentration can affect the color, opacity, tackiness, viscosity, stability, homogeneity, flavor, texture, and mouthfeel of the FIB-OIL, or the food product into which it is incorporated.

In some embodiments, oils can be added to the FIB-OIL such that the oil can comprise 0-80% by weight of the FIB-OIL. In other embodiments, oil can be added to the FIB-OIL such that the oil can comprise 5-20% by weight of the FIB-OIL. In other embodiments, oil can be added to the FIB-OIL such that the oil comprises 0.5-20% by weight of the FIB-OIL.

In some embodiments, emulsifiers can be added to the FIB-OIL such that the emulsifier can comprise 0-40% by weight of the FIB-OIL. In other embodiments, emulsifier can be added to the plant-based soluble dietary fiber such that the emulsifier can comprise 0.2-10% by weight of the FIB-OIL. In other embodiments, the emulsifier can comprise 0.05-10% by weight of the FIB-OIL.

In some embodiments, texture modifiers can be added to the FIB-OIL to adjust texture, color, opacity, viscosity, cooking properties, flavor, as well as mouthfeel or viscosity to the desired level. Such texture modifiers are well known in the food industry, and can include one or more of polydextrose, modified whey protein, or hydrocolloids. Among other sources, polydextrose is commercially available under the brand name Litesse. Among other sources, modified whey protein is commercially available under the brand names Simplesse and Dairy-Lo. Hydrocolloids can include one or more of xanthan gum, guar gum, locust bean gum, carrageenan, or gum acacia.

In some embodiments, the FIB-OIL can further comprise modified whey protein, including but not limited to concentrate or isolate, that can comprise 0-10% by weight of the FIB-OIL. In other embodiments, the modified whey protein can comprise 2-3% by weight of the FIB-OIL.

In some embodiments, hydrocolloids can be added as needed to obtain the desired properties of mouthfeel, viscosity, appearance, flavor profile, etc., as is well known in the food industry.

Texture modifiers can be added to the FIB-OIL such the texture modifier comprises 0-10% by weight of the FIB-OIL. In embodiments comprising modified whey protein, it may be added in an amount of 1-5% by weight of the FIB-OIL. In embodiments comprising hydrocolloid, the hydrocolloid may be added in an amount of 0.05-5% by weight of the FIB-OIL.

In some embodiments, flavor modifiers may be added to the FIB-OIL as needed to enhance the flavor, as is well known in the food industry. In some embodiments, FIB-OIL may contain one or more preservatives such as potassium sorbate, sodium proprionate, benzoic acid, and other known additives, to adjust water activity or pH or to enhance shelf-life stability.

For embodiments that are either liquid or frozen, the FIB-OIL can be made by first mixing the desired ingredients in the water. The mixture may be further emulsified with a blender, mixer, homogenizer, or similar process. A solid FIB-OIL can be made by freezing the resulting aqueous mixture.

For embodiments that are in dry form, the FIB-OIL can be made by compounding the desired dry ingredients into a substantially homogeneous dry mix.

Embodiments of the liquid FIB-OIL can resemble liquid edible oils in density, viscosity and appearance. They can be applied to food by dipping, coating, spray-coating, drizzling, marinating, or the like. After the mixture is applied to the food, the food can be heated in a pan on a stove top, in a conventional oven, or a microwave oven. Alternatively, the FIB-OIL-containing mixture may be heated, for example in a pan, and the food cooked in the heated mixture.

Embodiments of the frozen (solid) FIB-OIL can be incorporated into foods by blending, spreading, and other known techniques. Alternatively, the solid FIB-OIL can be melted to a liquid and used as a liquid FIB-OIL.

Embodiments of the dry FIB-OIL can be incorporated into dry food mixes, and further processed as other dry food mixes known in the industry are processed. The dry FIB-OIL can also be compounded into a paste with either water or oil. Alternatively, the dry FIB-OIL can be dissolved into an aqueous mixture and used as described above.

The plant-based soluble dietary fiber base of the FIB-OIL provides a heat-stable base that can withstand cooking temperatures of the food into which it is incorporated or the cooking temperatures used to prepare food. Trace sugars and carbohydrates in the present FIB-OIL allow Maillard browning with protein components in the food. Crystallization and/or caramelization of trace sugars or carbohydrates can impart a crisp texture to foods, when desired.

The FIB-OIL of the present application can be used like typical fats and oils in cooking, baking, sautéing, frying, and food preparation. Among other things, they can be directly substituted for and/or combined with oil in non-heated food compositions like dressings, spreads, dips, etc.; directly substituted for and/or combined with oil in baked food compositions like cakes, muffins, breads, breadings, coatings (for vegetables, proteins, etc.); directly substituted for and/or combined with oil in fried food compositions (pan-fried, par-fried, sautéed, roasted, etc.); and directly substituted for and/or combined with shortening for frozen biscuits, puff pastry, etc.

### Example 1

The oil and fat substitute FIB-OIL was used to bake cupcakes. It was compared to a control containing corn oil. The ingredients for the cupcakes were as set forth in Table 1 below.

TABLE 1

| | | | 50/50 Oil |
|---|---|---|---|
| | Control | Blank | Substitute |
| | 1 | 2 | 3 |
| | (grams) | (grams) | (grams) |
| Mix Base | 100.625 | 100.625 | 100.625 |
| Corn Oil | 12.38 | | |
| Oil Substitute | | | 12.38 |
| 50/50 (FIB-OIL) | | | |
| Total | 113.005 | 100.625 | 113.005 |

The composition of the mix base was as set forth in Table 2 below.

TABLE 2

| | Mix Base |
|---|---|
| | % |
| Water | 27.70 |
| Eggs | 18.63 |
| Betty Crocker Yellow Cake Mix | 53.66 |
| Total | 100.00 |

The oil substitute 50/50 (FIB-OIL) was prepared by placing 50% by weight Fibersol-2 and 50% by weight water in a plastic bottle and shaking. The mixture was allowed to sit overnight to ensure full dissolution of the ingredients. The mixture in the bottle was gently shaken before use.

The batter was poured into muffin pans lined with paper liners. The cupcakes were baked at 425° F. for 25 minutes. The mix base was first mixed in a KitchenAid home mixer without the addition of any oil or oil substitute. It was then portioned and the corn oil or liquid FIB-OIL was added to the appropriate portion and manually whisked for about 60 seconds. The cupcakes were evaluated for sensory results, set forth in Table 3 below, based on a scale where 1=much less than the control, 2=slightly less than the control, 3=same as control, 4=slightly more than control, and 5=much more than control.

TABLE 3

| | | | | Texture | | | | |
|---|---|---|---|---|---|---|---|---|
| Trial # | Cell size | Density | Height | (Firmness) | Dryness | Flavor | Notes | Description |
| 1 | 3 | 3 | 3 | 3 | 3 | 3 | | Control |
| 2 | 3 | 1 | 3 | 4 | 5 | 1 | Angel food-like, sweeter, flavor profile | Blank |
| | | | | | | | different | |
| 3 | 4 | 2 | 3 | 1 | 2 | 3 | fluffy | 50/50 Oil |
| | | | | | | | | Substitute |
| | | | | | | | | (FIB-OIL) |

Overall, the cupcakes with oil (the control) and cupcakes with the 50/50 oil substitute (FIB-OIL) “passed”, while the blank (no oil or oil substitute (FIB-OIL)) was considered to “fail”.

### Example 2

FIB-OILs were used to roast potato fries. Similar potato fries were also cooked in corn oil as a control. The potato fries were coated with various compositions of oil substitutes, as shown in Table 4 below. The (FIB-OIL) mixtures were mixed in the same manner described in example 1 and included a commercially available emulsifier, CITREM.

TABLE 4

| | Coating Trial: | | | | | | | | | | |
|---|---|---|---|---|---|---|---|---|---|---|---|
| | Control: | 1 | 2 | 3 | 4 | 5 | 6 | 7 | 8 | 9 | 10 |
| | (%) | (%) | (%) | (%) | (%) | (%) | (%) | (%) | (%) | (%) | (%) |
| Corn Oil | 100 | 0.5 | 5.8 | 9.5 | 1.5 | 0.5 | 0.5 | 5 | 10 | 10 | 10 |
| Fibersol-2 | 0 | 38 | 28.7 | 36 | 26 | 41 | 34 | 36.5 | 32 | 39.25 | 25 |
| Citrem | 0 | 0.5 | 0.5 | 0.3 | 0.25 | 1 | 0.25 | 1 | 1 | 0.75 | 1 |
| Water | 0 | 61 | 65 | 54.2 | 72.25 | 57.5 | 65.25 | 57.5 | 57 | 50 | 64 |
| Total | 100 | 100 | 100 | 100 | 100 | 100 | 100 | 100 | 100 | 100 | 100 |

| | Coating Trial: | | | | | | | | | |
|---|---|---|---|---|---|---|---|---|---|---|
| | 11 | 12 | 13 | 14 | 15 | 16 | 17 | 18 | 19 | 20 |
| | (%) | (%) | (%) | (%) | (%) | (%) | (%) | (%) | (%) | (%) |
| Corn Oil | 5 | 6 | 10 | 2.5 | 0.5 | 1.4 | 2.3 | 5.5 | 0.5 | 5.8 |
| Fibersol-2 | 33 | 43.75 | 28 | 47.25 | 26 | 29.6 | 43.6 | 25 | 47.5 | 40 |
| Citrem | 0.25 | 0.25 | 0.25 | 0.25 | 1 | 1 | 0.85 | 0.6 | 1 | 1 |
| Water | 61.75 | 50 | 61.75 | 50 | 72.5 | 68 | 53.25 | 68.9 | 51 | 53.2 |
| Total | 100 | 100 | 100 | 100 | 100 | 100 | 100 | 100 | 100 | 100 |

Potatoes were peeled, cut into ½″ fries, soaked in brine for 1 hour, rinsed, and dabbed with paper towel to remove excess moisture. 100 gram portions of fries were weighed into plastic sandwich bags. 10 g of coating was added to each bag of fries. The bags of fries were shaken and manipulated to distribute the coating over the entire fry surface. Fries were then placed on baking tray and baked for 50 minutes at 425 F. Samples were then evaluated for sensory attributes and adhesion to baking tray using a 9-point scale, as set forth in Table 5 below. Ratings were relative to control. When the control was in the middle range of the characteristic in question, 1=much less than control, 5=same as control, and 9=much more than control. When the control was at the bottom range of the characteristic in question, 1=control, 5=greater than control, and 9=much greater than control.

TABLE 5

| | Coating Trial: | | | | | | | | | | | | | | | | | | | | |
|---|---|---|---|---|---|---|---|---|---|---|---|---|---|---|---|---|---|---|---|---|---|
| | Control | 1 | 2 | 3 | 4 | 5 | 6 | 7 | 8 | 9 | 10 | 11 | 12 | 13 | 14 | 15 | 16 | 17 | 18 | 19 | 20 |
| Hot Tack | 1 | 7 | 3 | 5 | 7 | 5 | 5 | 2 | 6 | 2.5 | 6 | 5 | 3 | 1 | 8 | 6 | 3.5 | 4 | 6 | 6 | 4 |
| Overall Flavor | 5 | 4 | 6 | 3 | 2.5 | 7 | 5.5 | 6.5 | 3 | 3 | 3 | 6 | 7 | 6 | 7 | 7 | 3 | 6 | 6 | 3.5 | 4 |
| Sweetness | 1 | 1 | 1 | 1 | 1 | 3 | 2 | 2 | 1 | 1.5 | 1.5 | 1 | 1 | 1.5 | 2 | 2 | 1 | 1.5 | 1 | 2 | 1 |
| Oily Flavor | 5 | 1 | 2 | 2 | 1 | 1 | 1 | 2 | 1.5 | 1 | 2 | 1 | 1 | 2.5 | 1 | 1 | 1 | 1 | 1 | 1 | 1 |
| Flavor Off notes | 1 | 2 | 1 | 2 | 3 | 5 | 3 | 2 | 2 | 2 | 2 | 2.5 | 6 | 2 | 2.5 | 3 | 2 | 2 | 3 | 2 | 2 |
| Browning | 5 | 7 | 6.5 | 5 | 5.5 | 8 | 8 | 7 | 6 | 6.5 | 6.5 | 7 | 8 | 7 | 7 | 7 | 8 | 7.5 | 6.5 | 6 | 7 |
| Crispiness | 5 | 6.5 | 7 | 5 | 3 | 8 | 6.5 | 7 | 5 | 4.5 | 5.5 | 4.5 | 8.5 | 6 | 7 | 6 | 2.5 | 7 | 4 | 3 | 5 |
| Tackiness | 1 | 1 | 2.5 | 2 | 1 | 5 | 3 | 1.5 | 1 | 2 | 3 | 2.5 | 1.5 | 2.5 | 2.5 | 3.5 | 1 | 1 | 1 | 1.5 | 2 |
| Savory | 5 | 3 | 3 | 4.5 | 2.5 | 5 | 4 | 5 | 3 | 3.5 | 3 | 6 | 3.5 | 4 | 5 | 3 | 2.5 | 5 | 6 | 3.5 | 3 |

While varying in appearance, texture, and/or flavor, all samples were rated as “pass.”

### Example 3

A FIB-OIL was used to make creamy garlic dressing. Dressing was also prepared using extra-virgin olive oil as a control. The ingredients in the dressings are set forth in Table 6 and 7 below.

TABLE 6

| | Control | Exp |
|---|---|---|
| Ingredient | % | % |
| Base Mix | 63.47 | 63.47 |
| Extra-virgin Olive Oil | 36.53 | |
| Oil Substitute X (FIB-OIL) | | 36.53 |
| Total | 100.00 | 100.00 |

TABLE 7

| Base Mix | % |
|---|---|
| black pepper | 0.14 |
| Italian seasoning | 0.14 |
| salt | 0.35 |
| plain yogurt, fat-free | 53.52 |
| white vinegar | 41.66 |
| garlic clove, put through press | 4.19 |
| Total | 100.00 |

The oil substitute had the following composition, as set forth in Table 8.

TABLE 8

| Oil Substitute X | |
|---|---|
| (FIB-OIL) | Exp |
| Ingredient | (grams) |
| Fibersol-2 | 18.15 |
| Water | 18.15 |
| Xanthan Gum | 0.02 |
| NaCl | 0.2 |
| Total | 36.52 |

The oil substitute (FIB-OIL) was mixed using the process of Example 1.

The base mix ingredients were whisked together in a small bowl. They were allowed to stand for 10 minutes to rehydrate dried herbs and blend flavors. The base mix was divided into desired portions. The oil or oil-substitute (FIB-OIL) was whisked into the base mix portions. The resulting dressing was evaluated by four panelists with the results, as shown in Table 9 below.

TABLE 9

Comments

| Sample | Panelist 1 | Panelist 2 | Panelist 3 | Panelist 4 |
|---|---|---|---|---|
| Control | | Best | too much | Best |
| | | | vinegar | |
| Exp | Best | | | Best |

Both the control and the dressing with the (FIB-OIL) oil substitutes were determined to “pass”.

### Example 4

The FIB-OIL was used to make balsamic vinaigrette dressing. Dressing was also prepared using extra-virgin olive oil as a control. The ingredients in the dressings are set forth in Table 10 and 11 below.

TABLE 10

| | Control | Exp 1 | Exp2 |
|---|---|---|---|
| Balsamic Vinaigrette | (grams) | (grams) | (grams) |
| Base Mix | 50.00 | 50.00 | 50.00 |
| Cntl Extra-Virgin Olive Oil | 54.00 | | |
| Oil Substitute R1 (FIB-OIL) | | 54.00 | |
| Oil Substitute Q7 (FIB-OIL) | | | 54.00 |
| Total | 104.00 | 104.00 | 104.00 |

TABLE 11

| Base Mix: | % |
|---|---|
| balsamic vinegar | 59.50 |
| honey | 7.00 |
| Dijon mustard | 5.00 |
| shallot, minced | 25.00 |
| garlic, minced | 3.00 |
| fresh ground black pepper | 0.22 |
| salt | 0.28 |
| Total | 100.00 |

The (FIB-OIL) oil substitutes had the following compositions, as set forth in Table 12.

TABLE 12

| | |
|---|---|
| Oil Substitute Formulations | % |

| Ingredients | R1 | Q7 |
|---|---|---|
| Water | 65 | 66.30 |
| Fibersol-2 | 25 | 33.15 |
| Solec E (Lecithin/Emulsifier) | — | 0.55 |
| Litesse (polydextrose) | 10 | — |
| Total | 100 | 100 |

The (FIB-OIL) oil substitutes were mixed using the process of Example 1.

The base mix ingredients were whisked together in a small bowl. They were allowed to stand for 10 minutes to blend flavors. The base mix was divided into desired portions. The oil or (FIB-OIL) oil-substitutes were each whisked into the base mix portions. The resulting dressings were evaluated by four panelists where two panelists preferred the control and two panelists preferred the dressing with (FIB-OIL) oil substitute R1. The control had a very oily mouthfeel and mouthcoating. Both the control and the dressing with (FIB-OIL) oil substitute R1 had good flavor profiles.

All three dressings were determined to “pass”.

### Example 5

Mirepoix was sautéed using a corn oil as a control and a (FIB-OIL) oil substitute as an experimental. The (FIB-OIL) was prepared with a composition and in manner like that of Example 1. The mirepoix had the following composition, as set forth in Table 13.

TABLE 13

| Mirepoix | Amount | | | |
|---|---|---|---|---|
| Ingredients | Control | | Exp | |
| Oil Substitute 50/50 (FIB-OIL) | — | | 2 | tablespoons |
| Corn oil | 2 | tablespoons | — | |
| yellow onion, medium diced | 1 | cup | 1 | cup |
| carrot, medium dice | ½ | cup | ½ | cup |
| celery, medium dice | ½ | cup | ½ | cup |

The oil, onions, and carrots were added to a medium size skillet over medium high heat. They were sautéed for 2 to 4 minutes. The celery was then added and sautéed for another 4 to 6 minutes or until soft.

Experimental oil substitute (FIB-OIL) performed successfully in place of corn oil control. Both control and experimental facilitated cooking of onion, carrots, and celery. The appearance of experimental during sauté was different than control but end result was similar and satisfactory. Both mirepoix mixes were deemed to “pass”.

### Example 6

A marinara sauce was prepared with the (FIB-OIL) oil substitute of Example 1. A control with extra-virgin olive oil was also prepared. The sauces had the compositions set forth in Table 14.

TABLE 14

| Marinara Sauce | Amount | | | |
|---|---|---|---|---|
| Ingredients | Control | | Exp | |
| Oil Substitute 50/50 (FIB-OIL) | — | | 1 | cup |
| extra-virgin olive oil | ¼ | cup | ¼ | cup |
| yellow onion, diced | ½ | cup | ½ | cup |
| fresh garlic, minced | 2 | tablespoons | 2 | tablespoons |
| tomatoes, peeled, chopped | 1 | can (28 oz) | 1 | can (28 oz) |
| fresh basil, chopped | ½ | cup | ½ | cup |
| salt | 2 | teaspoons | 2 | teaspoons |
| ground black pepper | ½ | teaspoon | ½ | teaspoon |

The oil was heated in a medium saucepan over medium-high heat. The onion and garlic were sautéed, stirring, until lightly browned, about 5 minutes. The tomatoes were added with juices and basil, and brought to a boil. The heat was reduced and the sauces were simmered, uncovered for about 25 to 30 minutes or until thickened. The salt and pepper were added.

The (FIB-OIL) oil substitute performed successfully in place of extra-virgin olive oil control. Both the control and experimental facilitated browning/cooking of onion and garlic. The appearance of the experimental during sauté was different than control but end result was similar and satisfactory. The sauce with the (FIB-OIL) oil substitute was considered to “pass”.

### Example 7

Stir fry vegetables were sautéed in (FIB-OIL) oil substitutes and compared to those sautéed in corn oil. The (FIB-OIL) oil substitutes had the formulas set forth in Table 15.

TABLE 15

| | Experimental (FIB-OIL) Oil | | |
|---|---|---|---|
| | Substitutes | | |
| Oil Formulations | Q2 | Q4 | Q7 |
| Ingredients | (%) | (%) | (%) |
| Water | 65 | 65 | 66.30 |
| Fibersol-2 | 25 | 25 | 33.15 |
| Solec E (Lecithin/Emulsifier) | — | — | 0.56 |
| Litesse (polydextrose) | 10 | — | — |
| Litesse ® Ultra ™ (polydextrose) | — | 10 | — |
| Total | 100 | 100 | 100 |

The oil substitutes were mixed using the procedure of Example 1.

The stir fry vegetables were sautéed using the following quantities of ingredients, as set forth in Table 16.

TABLE 16

| | Amount | | | | | | | |
|---|---|---|---|---|---|---|---|---|
| Stir Fry Vegetables | | | Exp (FIB- | | Exp (FIB- | | Exp (FIB- | |
| Ingredients | Control | | OIL) Q2 | | OIL) Q4 | | OIL) Q7 | |
| Corn Oil | 3 | tablespoons | — | | — | | — | |
| (FIB-OIL) Oil Substitute Q2 | — | | 3 | tablespoons | — | | — | |
| (FIB-OIL) Oil Substitute Q4 | — | | — | | 3 | tablespoons | — | |
| (FIB-OIL) Oil Substitute Q7 | — | | — | | — | | 3 | tablespoons |
| onion, peeled and thin sliced | 1 | cup | 1 | cup | 1 | cup | 1 | cup |
| carrot, peeled and sliced | ½ | cup | ½ | cup | ½ | cup | ½ | cup |
| sugar snap peas, destemmed | 1 | cup | 1 | cup | 1 | cup | 1 | cup |
| red bell pepper, deseeded sliced thin | 1 | cup | 1 | cup | 1 | cup | 1 | cup |
| broccoli florets | 1 | cup | 1 | cup | 1 | cup | 1 | cup |

Three tablespoons of oil or (FIB-OIL) oil substitute was heated in a large skillet over medium-high heat. In each case, the onion and carrot were sautéed for 1 minute. The sugar snap peas, pepper, and broccoli were then added and sautéed for 5 minutes.

The (FIB-OIL) oil substitutes performed successfully in place of the corn oil. Both the control and the (FIB-OIL) oil substitutes facilitated cooking and tenderizing the vegetables. The (FIB-OIL) oil substitutes resulted in vegetables that had a less oily mouthfeel and fresher, more natural flavor than the control. By the end of the cook time, the (FIB-OIL) oil substitutes Q2 and Q7 had become much drier and formed a residual film. (FIB-OIL) oil substitute Q4 still looked wet. It had also dried but to less of an extent than Q2 or Q7. The control corn oil looked as expected with oily residue in the pan. Adding a tablespoon or two of additional water to the dried (FIB-OIL) oil substitute samples reconstituted, resulting in the return of an oily appearance.

### Example 8

Chicken and vegetables were sautéed in the (FIB-OIL) oil substitute R-1 of Example 4 and compared to those sautéed in corn oil. The sautées had the compositions set forth in Table 17.

TABLE 17

| Stir Fry Vegetables | Amount | | | |
|---|---|---|---|---|
| Ingredients | Control | | Exp R1 | |
| Corn Oil | 3 | tablespoons | — | |
| (FIB-OIL) Oil Substitute R1 | — | | 3 | tablespoons |
| Chicken breast, boneless, skinless, | 1 | lb. | 1 | lb. |
| ½″ strips | | | | |
| onion, peeled and thin sliced | 1 | cup | 1 | cup |
| carrot, peeled and sliced | ½ | cup | ½ | cup |
| sugar snap peas, destemmed | 1 | cup | 1 | cup |
| yellow squash, ½″ slices | 1 | cup | 1 | cup |
| broccoli florets | 1 | cup | 1 | cup |

Three tablespoons of oil or (FIB-OIL) oil substitute was heated in a large skillet over medium heat. The chicken was added and cooked 4 to 6 minutes or until cooked through. The onion and carrot were added and sautéed for an additional 3 minutes. The sugar snap peas, broccoli, and squash were added, and continued to sauté for an additional 5 minutes or until cooked to desired texture. The total cooking time was 12-14 minutes.

The sauté made with (FIB-OIL) oil substitute performed successfully in place of the corn oil. The control and the (FIB-OIL) oil substitute facilitated cooking and tenderizing the vegetables. The (FIB-OIL) oil substitute provided a product with a less oily mouthfeel than the control. By the end of the cook time, the (FIB-OIL) oil substitute had become somewhat drier and formed a residual film. The dryness and the film were less than previous trials without chicken and when cooked at medium-high heat. The sauté prepared with the corn oil had, as expected, an oily residue in the pan.

### Example 9

Omelets were sautéed in both a control and several (FIB-OIL) oil substitutes. The omelets were prepared using the following ingredients of Table 18.

TABLE 18

| | |
|---|---|
| Omelet | Amount |

| Ingredients | Control | Oil Substitute |
|---|---|---|
| Corn Oil | 1 tablespoon | — |
| Exp (FIB-OIL) Oil | — | 1 tablespoon |
| Substitute | | |
| Egg, whisked | 2 tablespoons | 2 tablespoons |
| Salt | to taste | to taste |
| Black Pepper | to taste | to taste |

The oil substitutes tested had the compositions set forth in Table 19.

TABLE 19

| | (FIB-OIL) Oil Substitute Formulations | | | | | | | | | |
|---|---|---|---|---|---|---|---|---|---|---|
| | Q1 | Q2 | Q3 | Q4 | Q5 | Q6 | Q7 | Q8 | Q9 | Q10 |
| Ingredient | % | % | % | % | % | % | % | % | % | % |
| Water | 65.00 | 65.00 | 65.00 | 65.00 | 50.00 | 50.00 | 66.30 | 66.09 | 63.63 | 71.00 |
| Fibersol-2 | 35.00 | 25.00 | 25.00 | 25.00 | 25.00 | 25.00 | 33.15 | 33.04 | 31.81 | 25.00 |
| Solec E (Emulsifier) | | | | | | | 0.56 | | | |
| Solec A (Emulsifier) | | | | | | | | 0.87 | | |
| Ohly HCT (yeast cell walls) | | | | | | | | | 4.56 | |
| Psyllium (soluble fiber) | | | | | | | | | | 4.00 |
| Litesse (Polydextrose) | | 10.00 | | | 25.00 | | | | | |
| Litesse Two (Polydextrose) | | | 10.00 | | | | | | | |
| Litesse Ultra (Polydextrose) | | | | 10.00 | | 25.00 | | | | |
| Total | 100.00 | 100.00 | 100.00 | 100.00 | 100.00 | 100.00 | 100.00 | 100.00 | 100.00 | 100.00 |

Each (FIB-OIL) oil substitute was mixed using the procedure of Example 1.

Six eggs were cracked into a small bowl. Salt and pepper were added to taste. The eggs were whisked until blended. For each omelet, one tablespoon of oil or (FIB-OIL) oil substitute was heated in a mini sauté pan. Two tablespoons of egg mixture were placed in each pan. When the egg solidified, the omelet was turned over using a spatula. The omelet was then cooked for an additional minute or two until all of the egg had solidified.

The resulting omelets were evaluated and produced the results in Table 20.

TABLE 20

| Observations/Results | Q1 | Q2 | Q3 | Q4 | Q5 | Q6 | Q7 | Q8 | Q9 | Q10 |
|---|---|---|---|---|---|---|---|---|---|---|
| Residual Omelet/Pan | wet | dry | dry mod | dry mod | wet | dry | typical | wet | very wet | n/a |
| Moisture | | | | | | | | | | |
| Sweetness | slight | slight | slight | very | slight | | | slight | | n/a |
| | | | | slight | | | | | | |
| Notes | | | slight fatty | fatty | fatty | soapy | | | slow to boil, | FAIL - too |
| | | | notes | notes | notes | | | | beefy | thick gel |

All (FIB-OIL) oil substitutes were considered to pass except for those made with (FIB-OIL) oil substitutes Q9 and Q10, which failed.

### Example 10

Omelets were sautéed in both a control and several (FIB-OIL) oil substitutes. The omelets were prepared using the following ingredients of Table 21.

TABLE 21

| | |
|---|---|
| Omelet | Amount |

| Ingredients | Control | Oil Substitute |
|---|---|---|
| Corn Oil | 1 tablespoon | — |
| Exp (FIB-OIL) Oil | — | 1 tablespoon |
| Substitute | | |
| Egg, whisked | 2 tablespoons | 2 tablespoons |
| Salt | to taste | to taste |
| Black Pepper | to taste | to taste |

The oil substitutes tested had the compositions set forth in Table 22.

TABLE 22

| | R1 | R2 | R3 | R4 | R5 | R6 | R7 | R8 | R9 | R10 | R11 | R12 | R13 | R14 |
|---|---|---|---|---|---|---|---|---|---|---|---|---|---|---|
| Ingredient | (%) | (%) | (%) | (%) | (%) | (%) | (%) | (%) | (%) | (%) | (%) | (%) | (%) | (%) |
| Water | 65 | 65 | 74.4 | 74.4 | 74.4 | 65 | 75 | 75 | 75 | 65 | 49.95 | 74.9 | 75 | 75 |
| Fibersol-2 | 25 | 25 | 25 | 25 | 25 | 25 | | | | 10 | 49.95 | 25 | | |
| Litesse | 10 | | | | | | 25 | | | | | | | |
| Litesse ® | | 10 | | | | 9.4 | | 25 | 24.4 | 25 | | | | |
| Ultra ™ | | | | | | | | | | | | | | |
| Solec E | | | 0.6 | | | 0.6 | | | 0.6 | | | | | |
| Solec 162 | | | | 0.6 | | | | | | | | | | |
| Citrem | | | | | 0.6 | | | | | | | | | |
| SuperEnvision | | | | | | | | | | | 0.1 | 0.1 | | |
| NutriSource | | | | | | | | | | | | | 25 | |
| PHGG | | | | | | | | | | | | | | |
| (Partially | | | | | | | | | | | | | | |
| Hydrolyzed | | | | | | | | | | | | | | |
| Guar Gum) | | | | | | | | | | | | | | |
| Perfect Pass | | | | | | | | | | | | | | 25 |
| PHGG | | | | | | | | | | | | | | |
| (Partially | | | | | | | | | | | | | | |
| Hydrolyzed | | | | | | | | | | | | | | |
| Guar Gum) | | | | | | | | | | | | | | |
| Total: | 100.00 | 100.00 | 100.00 | 100.00 | 100.00 | 100.00 | 100.00 | 100.00 | 100.00 | 100.00 | 100.00 | 100.00 | 100.00 | 100.00 |

Each (FIB-OIL) oil substitute was mixed using the procedure of Example 1.

Six eggs were cracked into a small bowl. Salt and pepper were added to taste. The eggs were whisked until blended. For each omelet, one tablespoon of oil or (FIB-OIL) oil substitute was heated in a mini sauté pan. Two tablespoons of egg mixture were placed in each pan. When the egg solidified, the omelet was turned over using a spatula. The omelet was then cooked for an additional minute or two until all of the egg had solidified.

The resulting omelets were evaluated and produced the results in Table 2

TABLE 23

| Observations/ | | | | | | | | | | | | | | |
|---|---|---|---|---|---|---|---|---|---|---|---|---|---|---|
| Results | | | | | | | | | | | | | | |
| Residual | | R2 | | | R5 | | | R8 | R9 | | | | | |
| Omelet/Pan | R1 | very | R3 | R4 | most | R6 | R7 | very | very | R10 | R11 | R12 | R13 | R14 |
| Moisture | wet | wet | wet | FAIL | dry | mod + wet | wet | wet | wet | wet | n/a | wet | wet | wet |
| Sweetness | slight | slight | slight | FAIL | none | slight | none | sweet | very | very slight/ | n/a | none? | none | none |
| | | | | | | | | | slight | none | | | | |
| Notes | | | | undissolved | | | | clear | | | not run - | | syrupy | syrupy |
| | | | | | | | | | | | thick | | | |

All (FIB-OIL) oil substitutes were considered to pass except for those made with (FIB-OIL) oil substitutes R4 and R11, which failed.

### Example 11

Biscuits were made using a frozen (FIB-OIL) oil substitute and compared to those made using butter. The frozen (FIB-OIL) oil substitute was made by dissolving 125 g Fibersol-2 in 125 g water. The mixture was poured into a 1-quart Ziploc bag. The sealed bag was placed on a baking tray and placed in a freezer overnight.

The biscuits had the compositions set forth in Table 24.

TABLE 24

| | Cntl | Exp |
|---|---|---|
| Flaky Biscuits | (grams) | (grams) |
| Unbleached All-Purpose Flour | 240.75 | 240.75 |
| Baking powder | 8.00 | 8.00 |
| Salt | 5.75 | 5.75 |
| Baking soda | 1.50 | 1.50 |
| Butter, salted | 75.50 | 0.00 |
| Buttermilk | 168.50 | 168.50 |
| Frozen (FIB-OIL) Oil Substitute | 0.00 | 75.50 |
| FS-50/50 | | |
| Total | 500.00 | 500.00 |

The oven was pre-heated to 450 F. A baking sheet was lined with parchment paper. The flour, baking powder, salt, and baking soda were sifted in the bowl of a food processor fitted with a metal blade. The butter or frozen (FIB-OIL) oil substitute was added and the food processor was run for about ten seconds, or until coarse crumbs were formed. The crumb mixture was transferred to a mixing bowl and the buttermilk was quickly stirred in. The mixture was pressed so that the dough came together. The dough was turned out onto a lightly floured surface and kneaded by folding the dough onto itself 7 or 8 times. The dough was rolled out to ½ inch thickness and cut into biscuit shapes. The biscuits were placed on a baking pan and brushed with half and half. They were baked for 10 to 12 minutes or until golden.

Both formulas made satisfactory biscuits. The frozen (FIB-OIL) oil substitute exhibited layers after baking but there were not as many or as distinct as in the biscuits made with the control. The biscuits made with the frozen (FIB-OIL) oil substitute had a slightly different appearance and texture.

### Example 12

An (FIB-OIL) oil substitute paste and an (FIB-OIL) oil substitute were used to make croissants and compared to those made with butter. The oil substitute paste comprised the ingredients set forth in Table 25.

TABLE 25

| (FIB-OIL) Oil Substitute R1-50 | |
|---|---|
| Paste | g |
| Water | 120.00 |
| Fibersol-2 | 240.00 |
| Litesse | 40.00 |
| Egg white | 48.00 |
| Total | 448.00 |

The (FIB-OIL) oil substitute paste was made by the following process. Water, Fibersol-2, and Litesse were added to sauce pan, covered, and heated to boiling. 48 g egg white was added to Kitchen-Aide mixer with whisk attachment. Egg whites were whisked at high speed to fluffy white peak formation. While whisking, the hot syrup was drizzled into fluffed egg white. After all syrup was added, paste was poured into glass baking dish, allowed to cool, and refrigerated overnight.

The liquid (FIB-OIL) oil substitute comprised the ingredients set forth in Table 26.

TABLE 26

| (FIB-OIL) Oil Substitute R1-50 | % |
|---|---|
| Water | 30.00 |
| Fibersol-2 | 60.00 |
| Litesse | 10.00 |
| Total | 100.00 |

The water, Fibersol-2, and Litesse were added to a plastic bottle, shaken, and allowed to dissolve.

The croissant doughs had the compositions set forth in Table 27.

TABLE 27

| | Cntl | Exp |
|---|---|---|
| Croissant Dough | (grams) | (grams) |
| All-Purpose Flour | 500.00 | 500.00 |
| Whole Milk | 350.00 | 350.00 |
| Granulated Sugar | 50.00 | 50.00 |
| Butter, unsalted, softened | 29.00 | 0.00 |
| (FIB-OIL) Oil Substitute R1-50 | 0.00 | 29.00 |
| Instant Yeast | 7.50 | 7.50 |
| Salt | 11.40 | 11.40 |
| Total | 947.90 | 947.90 |

The croissant “butter” layer had the compositions set forth in Table 28.

TABLE 28

| | Cntl | Exp |
|---|---|---|
| Croissant Butter Layer | (grams) | (grams) |
| Butter, unsalted, cold | 258.00 | 0.00 |
| (FIB-OIL) Oil Substitute R1-50 | 0.00 | 258.00 |
| Paste, cold | | |

The croissants were made using the following steps:
1. In the bowl of a standing mixer fitted with a dough hook, add all the ingredients for the dough and knead on medium speed for a few minutes or until the dough comes together.
2. Place the dough on a floured surface, knead it together for a minute and form it into a disk, transfer the dough into a lightly floured bowl, lightly sprinkle the top with flour, cover with plastic wrap and pop it in the fridge for a minimum of 1 hour
3. Slice the cold butter/(FIB-OIL) Oil Substitute R1-50 paste into thin strips and place them in the center of a piece of parchment paper, place another piece of parchment paper on top of the cold butter/(FIB-OIL) Oil Substitute R1-50 paste and using a rolling pin, roll the cold butter/(FIB-OIL) Oil Substitute R1-50 paste into a 7″ square piece trimming the edges and placing those little bits on top of the square and adhering them in the cold butter/(FIB-OIL) Oil Substitute R1-50 paste square with the rolling pin. Place the cold butter/(FIB-OIL) Oil Substitute R1-50 paste in the fridge.
4. Place the dough on a lightly floured surface, roll it out to a 10½″ square, brush off any excess cold butter/(FIB-OIL) Oil Substitute R1-50 paste from the surface of the dough and place the cold square of cold butter/Oil Substitute R1-50 paste (if the cold butter/(FIB-OIL) Oil Substitute R1-50 paste is too soft, stick it in the fridge a bit longer) in the center but on the opposite side as the dough (one of the corners of the cold butter/(FIB-OIL) Oil Substitute R1-50 paste should line up with one of the flat sides of the dough) fold in each corner to enclose the cold butter/(FIB-OIL) Oil Substitute R1-50 paste (brushing off any excess flour as you go) then sprinkle a touch of flour on the very top and using your rolling pin, roll it out to 8″ wide by a 24″ long rectangle, fold in thirds (like a letter) making sure to brush off any excess flour, place it on a parchment paper lined baking sheet, cover with plastic wrap and stick it in the fridge for 30 minutes.
5. Repeat the rolling out (into an 8×24″ rectangle) and folding it in thirds method 2 more times making sure to chill in the fridge for 30 minutes in between (wrapped in plastic wrap). In total, you should have rolled and chilled 3 times, on the last time, place the dough in the fridge overnight.
6. Place the dough on a lightly floured surface and roll it out in a 8×44″ rectangle, if your kitchen is too warm, you might find that the dough starts resisting the stretching out part and shrink, if that happens, fold the dough into thirds, place it in the fridge for 15 minutes at a time and roll it out little by little.
7. Using a ruler or tape measure, measure the length of your rectangle so you can make sure it's the right size, trim the edges so you have a perfectly straight edge, and using the ruler as a guide, mark a spot every 6 inches (you should have 7 markings total) do the same thing at the bottom of dough so you get the right size.
8. Brush off any excess flour, cut out each square and then cut that square in half on a diagonal.
9. Lay each little triangle in front of you, brush off any excess flour from top and bottom, stretch it out at the largest side (at this point the pointed end isn't centered and it needs to be) stretch it just a bit to make sure the pointed end is centered.
10. Starting at the widest part of the triangle, roll it into a crescent shape pinching the ends together (they will come apart but this helps keep their shape), continue with the remaining croissants.
11. Place the croissants on your parchment paper lined baking sheets and place them somewhere slightly warm (around 75 to 80 degrees Fahrenheit) and allow them to proof for about an hour or so (they won't double in size but they will puff up just a little)
12. Meanwhile, line a couple large baking sheets with parchment paper and set aside. Whisk together an egg with some milk for the egg wash.
13. When ready to bake, arrange your oven racks on your lower and upper third of your oven, preheat oven to 400 degrees. Brush the tops of the croissants with the egg wash and bake for 20 to 25 minutes or until golden brown.

Both formulas made satisfactory croissants. The croissants made with the (FIB-OIL) oil substitutes exhibited layers after baking but not as many or as distinct as those in the croissant made with butter. The croissants made with (FIB-OIL) oil substitutes had a slightly different appearance and texture; they were less buttery and flaky but had a mild sweetness and surface crunch.

### Example 13

Pancakes were made using two pancake dry mixes made with (FIB-OIL) oil substitutes and compared to those made using corn oil. The pancakes were made using the following steps:
1. Dry ingredients were combined in large bowl.
2. Wet ingredients were combined in another large bowl.
3. Wet mixture was added to dry mixture.
4. Mixture was stirred and allowed to sit 10 minutes.
5. ¼ cup-portions of batter were poured onto hot, lightly greased griddle.
6. Pancakes were cooked over medium heat for 1 to 2 minutes on each side or until golden brown.

The pancakes had the compositions set forth in Table 29.

TABLE 29

| | Pancakes | Control | Exp 1 | Exp 2 |
|---|---|---|---|---|
| | INGREDIENTS | (grams) | (grams) | (grams) |
| Dry Ingredients | flour, all-purpose | 211.75 | 211.75 | 211.75 |
| | granulated sugar | 25.00 | 25.00 | 25.00 |
| | baking powder | 8.00 | 8.00 | 8.00 |
| | baking soda | 4.40 | 4.40 | 4.40 |
| | salt | 2.40 | 2.40 | 2.40 |
| | Fibersol-2 | — | 10.50 | 4.20 |
| | Litesse | — | 4.20 | 10.50 |
| Wet Ingredients | egg | 50.00 | 50.00 | 50.00 |
| | whole milk | 322.50 | 322.50 | 322.50 |
| | vinegar, white | 22.50 | 22.50 | 22.50 |
| | corn oil | 42.00 | — | — |
| | water | — | 27.30 | 27.30 |
| | Total: | 688.55 | 688.55 | 688.55 |

All formulas made satisfactory pancakes with no consistent differences in appearance, flavor, or texture.

### Example 14

Two experimental Microwave Chocolate Mug Cakes were made using dry mixes made with each of two (FIB-OIL) oil substitutes and water. The experimental samples were compared to a control formulation that used corn oil. The Microwave Chocolate Mug Cake dry mixes were made using the following steps:
1. Dry ingredients were combined to make dry mixes.
2. Corn oil was added to the control mix.
3. Water was added to the experimental mixes.
4. Samples were each cooked in microwave for 1 minute 45 seconds.

The Microwave Chocolate Mug Cakes had the compositions set forth in Table 30.

TABLE 30

| | Microwave Chocolate | | | |
|---|---|---|---|---|
| | Mug Cake | Control | Exp 1 | Exp 2 |
| | Ingredients | (grams) | (grams) | (grams) |
| Dry Mix | all-purpose flour | 30.25 | 30.25 | 30.25 |
| Compositions: | white sugar | 53.50 | 53.50 | 53.50 |
| | unsweetened cocoa powder | 10.40 | 10.40 | 10.40 |
| | baking soda | 1.10 | 1.10 | 1.10 |
| | salt | 1.20 | 1.20 | 1.20 |
| | milk powder, non-fat | 5.19 | 5.19 | 5.19 |
| | Fibersol-2 | — | 7.00 | — |
| | Litesse | — | 2.80 | 2.80 |
| | Perfect Pass PHGG | — | — | 7.00 |
| | (Partially Hydrolyzed | | | |
| | Guar Gum) | | | |
| | water | 54.31 | 72.51 | 72.51 |
| | corn oil | 28.00 | — | — |
| | Total: | 183.95 | 183.95 | 183.95 |

The control sample had a less fluffy appearance (approximately 50% of the risen height of the experimental samples) and burnt chocolate aroma and notes. Both experimental cakes were preferred in flavor, texture, and appearance compared to the control sample.

### Example 15

An oil and fat substitute comprises 5-80% by weight plant-based soluble dietary fiber, 0-80% by weight edible oil, and 0-40% by weight emulsifier in an aqueous mixture.

### Example 16

An oil and fat substitute of Example 15, or any one of the following Examples, wherein the plant-based soluble dietary fiber comprises at least one of corn fiber, wheat fiber, cereal grain fiber, pulse or legume fiber, polydextrose, or partially-hydrolyzed guar gum.

### Example 17

An oil and fat substitute of Examples 15 or 16, or any one of the following Examples, comprising 5-50% by weight plant-based soluble dietary fiber.

### Example 18

An oil and fat substitute of any one of Examples 15, 16, or 17, or any one of the following Examples, comprising 25-50% by weight plant-based soluble dietary fiber.

### Example 19

An oil and fat substitute of any one of Examples 15, 16, 17, or 18, or any one of the following Examples, comprising 0.5-20% by weight oil.

### Example 20

An oil and fat substitute of any one of Examples 15, 16, 17, 18, or 19, or any one of the following Examples, comprising 5-20% by weight oil.

### Example 21

An oil and fat substitute of any one of Examples 15, 16, 17, 18, 19, or 20, or any one of the following Examples, comprising 0.05-10% by weight emulsifier.

### Example 22

An oil and fat substitute of any one of Examples 15, 16, 17, 18, 19, 20, or 21, or any one of the following Examples, comprising flavor.

### Example 23

An oil and fat substitute of any one of Examples 15, 16, 17, 18, 19, 20, 21, or 22, or any one of the following Examples, further comprising 0-10% by weight texture modifiers.

### Example 24

An oil and fat substitute of any one of Examples 15, 16, 17, 18, 19, 20, 21, 22, or 23, or any one of the following Examples, comprising 1-5% by weight whey protein.

### Example 25

An oil and fat substitute of any one of Examples 15, 16, 17, 18, 19, 20, 21, 22, 23, or 24, or any one of the following Examples comprising 0.5-5% by weight hydrocolloid.

### Example 26

An oil and fat substitute of any one of Examples 16, 17, 18, 19, 20, 21, 22, 23, 24, or 25 comprising 5-80% by weight plant-based soluble dietary fiber in a dry form.

### Example 27

A dry mix comprises the oil and fat substitute of Example 26 and substantially no oil or fat.

What is claimed is:

1. An oil and fat substitute comprises 5-80% by weight plant-based soluble dietary fiber, 0-80% by weight edible oil, and 0-40% by weight emulsifier in an aqueous mixture.

2. The oil and fat substitute of claim 1 wherein the plant-based soluble dietary fiber comprises at least one of corn fiber, wheat fiber, cereal grain fiber, pulse or legume fiber, polydextrose, or partially-hydrolyzed guar gum.

3. The oil and fat substitute of claim 1 comprising 5-50% by weight plant-based soluble dietary fiber.

4. The oil and fat substitute of claim 1 comprising 25-50% by weight plant-based soluble dietary fiber.

5. The oil and fat substitute of claim 1 comprising 0.5-20% by weight oil.

6. The oil and fat substitute of claim 5 comprising 5-20% by weight oil.

7. The oil and fat substitute of claim 1 comprising 0.05-10% by weight emulsifier.

8. The oil and fat substitute of claim 7 comprising 0.2-10% by weight emulsifier

9. The oil and fat substitute of claim 1 further comprising flavor.

10. The oil and fat substitute of claim 1 further comprising 0-10% by weight texture modifiers.

11. The oil and fat substitute of claim 10 wherein the texture modifier comprises modified whey protein, which comprises 1-5% by weight of the oil and fat substitute.

12. The oil and fat substitute of claim 10 wherein the texture modifier comprises hydrocolloid, which comprises 0.5-5% by weight of the oil and fat substitute.

13. A dry mix comprises soluble dietary fiber and substantially no oil or fat.
